(19) United States
(12) Patent Application Publication
(10) Pub. No.: US 2018/0330279 A1
(43) Pub. Date: Nov. 15, 2018

(54) COMPUTER-READABLE RECORDING MEDIUM, LEARNING METHOD, AND LEARNING APPARATUS

(71) Applicant: FUJITSU LIMITED, Kawasaki-shi (JP)

(72) Inventor: Tomoya IWAKURA, Kawasaki (JP)

(73) Assignee: FUJITSU LIMITED, Kawasaki-shi (JP)

(21) Appl. No.: 15/973,035

(22) Filed: May 7, 2018

(30) Foreign Application Priority Data
May 12, 2017 (JP) 2017-096006

(51) Int. Cl. G06N 99/00

(52) U.S. Cl. CPC G06N 99/005; G06F 17/28

(57) ABSTRACT

A non-transitory computer-readable recording medium stores a learning program that causes a computer to execute a process including: acquiring learning data that is a learning object for a model in which data and confidence of the data are associated with each other; determining whether learning of the learning data is needed by comparing a predetermined condition with a decision result related to updating of the model accumulated for the learning data acquired at the acquiring; and excluding, from a learning object, the learning data of which learning is determined to be unneeded at the determining.

### CROSS-REFERENCE TO RELATED APPLICATION

This application is based upon and claims the benefit of priority of the prior Japanese Patent Application No. 2017-096006, filed on May 12, 2017, the entire contents of which are incorporated herein by reference.

### FIELD

The embodiment discussed herein is related to a computer-readable recording medium, a learning method, and a learning apparatus.

### BACKGROUND

In natural language processing, as examples, various types of machine learning are used, such as perceptron, SVMs (Support Vector Machines), PA (Passive-Aggressive), and AROW (Adaptive Regularization of Weight Vectors).

As an example, there is described a case where a word is picked out as a feature from a labeled text that is a learning object, and where a model in which this feature and confidence are associated with each other is learned according to a method called perceptron. In the perceptron method, each feature of each piece of learning data is cross-checked with a feature in the model to evaluate whether labeling is against the confidence of the model. In the perceptron method, a feature labeled against the confidence given by the model is classified as a wrong instance, and the model is caused to learn this wrong instance to update the model.

Patent Document 1: Japanese Laid-open Patent Publication No. 2014-102555

Patent Document 2: Japanese Laid-open Patent Publication No. 2005-44330

However, in the conventional methods, cross-checking with the model and evaluation are repeated for all pieces of learning data. In other words, in the conventional methods, cross-checking with the model and evaluation are performed every time, even for learning data for which classification has been correct for multiple times consecutively. As a result, in the conventional methods, it is needed to have a certain amount of calculation for executing a learning process, and thus reducing the amount of calculation needed for the learning process is difficult.

### SUMMARY

According to an aspect of an embodiment, a non-transitory computer-readable recording medium stores a learning program that causes a computer to execute a process including: acquiring learning data that is a learning object for a model in which data and confidence of the data are associated with each other; determining whether learning of the learning data is needed by comparing a predetermined condition with a decision result related to updating of the model accumulated for the learning data acquired at the acquiring; and excluding, from a learning object, the learning data of which learning is determined to be unneeded at the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a learning apparatus according to a first embodiment;

FIG. 2 is a diagram illustrating an example of learning data;

FIG. 3 is a diagram illustrating an example of cross-checking between a feature and a model and updating of the model according to the first embodiment;

FIG. 4 is a diagram illustrating an example of cross-checking between a feature and a model and updating of the model according to the first embodiment;

FIG. 5 is a diagram illustrating an example of cross-checking between a feature and a model and updating of the model according to the first embodiment;

FIG. 6 is a diagram illustrating an example of cross-checking between a feature and a model and updating of the model according to the first embodiment;

FIG. 7 is a diagram illustrating an example of cross-checking between a feature and a model and updating of the model according to the first embodiment;

FIG. 8 is a diagram illustrating an example of cross-checking between a feature and a model and updating of the model according to the first embodiment;

FIG. 9 is a diagram illustrating an example of determination with respect to cross-checking of a feature according to the first embodiment;

FIG. 10 is a flowchart illustrating a procedure of a learning process according to the first embodiment;

FIG. 11 is a diagram illustrating an example of cross-checking between a feature and a model and updating of the model according to a comparative example;

FIG. 12 is a diagram illustrating an example of cross-checking between a feature and a model and updating of the model according to the comparative example;

FIG. 13 is a diagram illustrating an example of cross-checking between a feature and a model and updating of the model according to the comparative example;

FIG. 14 is a diagram illustrating an example of cross-checking between a feature and a model and updating of the model according to the comparative example;

FIG. 15 is a diagram illustrating an example of cross-checking between a feature and a model and updating of the model according to the comparative example;

FIG. 16 is a diagram illustrating an example of cross-checking between a feature and a model and updating of the model according to the comparative example;

FIG. 17 is a diagram illustrating an example of cross-checking between a feature and a model and updating of the model according to the comparative example;

FIG. 18 is a diagram illustrating an example of cross-checking between a feature and a model and updating of the model according to the comparative example;

FIG. 19 is a flowchart illustrating another procedure of the learning process according to the first embodiment;

FIG. 20 is a flowchart illustrating another procedure of the learning process according to the first embodiment;

FIG. 21 is a flowchart illustrating another procedure of the learning process according to the first embodiment; and

FIG. 22 is a diagram illustrating a hardware configuration example of a computer that executes a learning program according to the first embodiment.

### DESCRIPTION OF EMBODIMENT

Preferred embodiments of the present invention will be explained with reference to accompanying drawings. These embodiments are only examples and configurations and the like are not limited to those of the embodiments.

### Example of Learning Apparatus

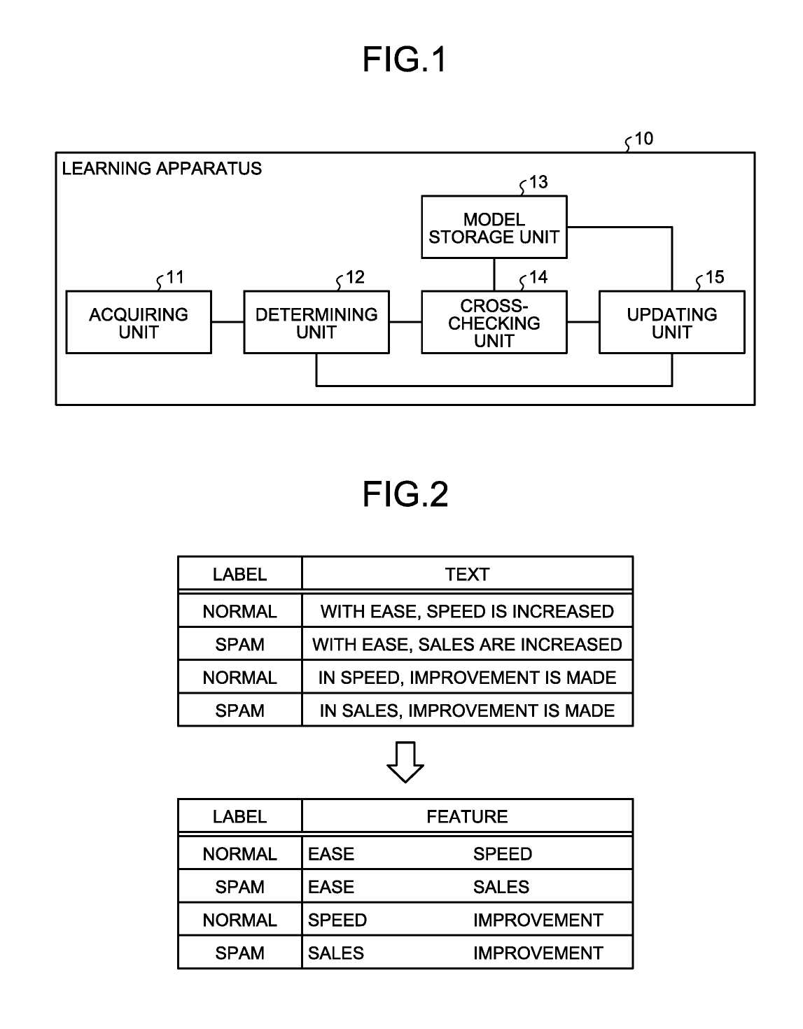

FIG. 1 is a block diagram illustrating a functional configuration of a learning apparatus according to a first embodiment. A learning apparatus 10 illustrated in FIG. 1 executes a learning process of learning a model (e.g., a feature) in natural language processing. The learning apparatus 10 picks out a word as a feature from a labeled text that is a learning object, and performs cross-checking with a model in which this feature and confidence are associated with each other. The learning apparatus 10 classifies a feature labeled against the confidence of the model as a wrong instance, and causes the model to learn this wrong instance to update the model. The learning apparatus 10 according to the first embodiment accumulates therein a correct classification count for each piece of learning data with respect to the model, and excludes, from a learning object, learning data of which the correct classification count has become equal to or greater than a threshold, thereby reducing the amount of calculation needed for the learning process.

The learning apparatus 10 illustrated in FIG. 1 is a computer that realizes the learning process.

As one embodiment, the learning apparatus 10 can be implemented by installing a learning program that executes the learning process described above in a desired computer, as package software or online software. For example, by causing an information processing apparatus to execute the learning program described above, the information processing apparatus can be caused to function as the learning apparatus 10. The information processing apparatus in this description includes, within its scope, mobile communication terminals such as smartphones and mobile phones, slate terminals such as PDAs (Personal Digital Assistants), in addition to desktop and laptop personal computers. Implementation can be also made as a server apparatus that provides a service related to the learning process described above to a client, the client being a terminal apparatus used by a user. For example, the learning apparatus 10 accepts learning data labeled as a positive instance or a negative instance or identification information with which learning data can be loaded via a network or a storage medium. The learning apparatus 10 is implemented as a server apparatus to provide a learning service of outputting a model that is a result of executing the learning process described above with respect to the learning data. In this case, the learning apparatus 10 may be implemented as a Web server or may be implemented as a cloud to provide a service related to the learning process by outsourcing.

As illustrated in FIG. 1, the learning apparatus 10 according to the first embodiment includes an acquiring unit 11, a determining unit 12, a model storage unit 13, a cross-checking unit 14, and an updating unit 15. The learning apparatus 10 may include various functional units included in a known computer, such as various input devices or audio output devices, other than the functional units illustrated in FIG. 1.

The acquiring unit 11 acquires learning data that is a learning object of a model (described below). The learning data is a text including a label of a positive instance or negative instance and a feature amount. The acquiring unit 11 acquires a feature included in the text that is a learning object.

As one embodiment, the acquiring unit 11 can also read and acquire learning data saved in an auxiliary storage device, such as a hard disk or an optical disc, or in a removable medium, such as a memory card or a USB (Universal Serial Bus) memory. In addition, the acquiring unit 11 can also receive and acquire learning data from an external apparatus via a network.

The determining unit 12 compares a predetermined condition with a decision result related to a model for learning data accumulated for the learning data acquired by the acquiring unit 11, determines whether learning of the learning data is needed, and excludes, from a learning object, learning data of which learning is determined to be unneeded.

The model storage unit 13 stores a model in which data and confidence of the data are associated with each other. A model is learned through association of a feature included in a text and confidence with each other. A model learns, as a wrong instance, learning data including a label against the confidence assigned by the model, that is, against the confidence of the model. The model is empty at the initial phase of a learning process, and a feature and confidence thereof are newly registered by the updating unit 15 (described below). Alternatively, in this model, confidence associated with a feature is updated by the updating unit 15. The “confidence” referred to in this description indicates the probability of a spam, and thus it is described below as “spam score” merely to represent one aspect.

The cross-checking unit 14 cross-checks learning data of which learning is determined to be needed by the determining unit 12 with a model stored in the model storage unit 13, decides whether the learning data to be cross-checked is data used for updating the model, and accumulates therein a decision result for the learning data to be cross-checked. Specifically, the cross-checking unit 14 decides that the learning data to be cross-checked is data used for updating the model, when the learning data to be cross-checked includes a label against the confidence of the model, that is, when the classification is incorrect (wrong).

The cross-checking unit 14 decides that the learning data to be cross-checked is not data used for updating the model, when the learning data to be cross-checked includes a label corresponding to the confidence of the model, that is, when the classification is correct. The cross-checking unit 14 accumulates therein the correct classification count indicating the count for correctly classified instances for learning data decided as not data used for updating the model, that is, for data for which classification has been correct. When the correct classification count accumulated for the learning data acquired by the acquiring unit 11 is equal to or greater than a predetermined threshold, the determining unit 12 determines that learning of the learning data is unneeded.

The updating unit 15 updates a model stored in the model storage unit 13, on the basis of learning data to be cross-checked that is decided as data used for updating the model by the cross-checking unit 14. Specifically, the updating unit 15 updates, on the basis of a label, confidence associated with a feature matching the model, out of features in text data to be cross-checked that is decided as data used for updating the model. The updating unit 15 adds to the model at least one of features not matching the model, out of features in text data to be cross-checked that is decided as data used for updating the model.

### Example of Learning Data

FIG. 2 is a diagram illustrating an example of learning data. As illustrated in the upper part of FIG. 2, the acquiring unit 11 acquires a text assigned with a label “spam” or “normal” as learning data.

When learning data is acquired in this manner, the acquiring unit 11 extracts a noun included in the text by, for example, performing a morphological analysis and decomposing the text into morphemes. Accordingly, as illustrated in the lower part of FIG. 2, the correspondence relationship of a label and a feature is extracted. For example, for a text “with ease, speed is increased” in the first line, “ease” and “speed” are extracted as features. For a text “with ease, sales are increased” in the second line, “ease” and “sales” are extracted as features. For a text “in speed, improvement is made” in the third line, “speed” and “improvement” are extracted as features. For a text “in sales, improvement is made” in the fourth line, “sales” and “improvement” are extracted as features.

Process in Learning Apparatus

Next, a learning process in the learning apparatus 10 is described. As an example, there is assumed a case where the learning data illustrated in FIG. 2 is acquired, and a model used for classifying input text into one of classes of “spam” and “normal” is learned according to a method called “perceptron”.

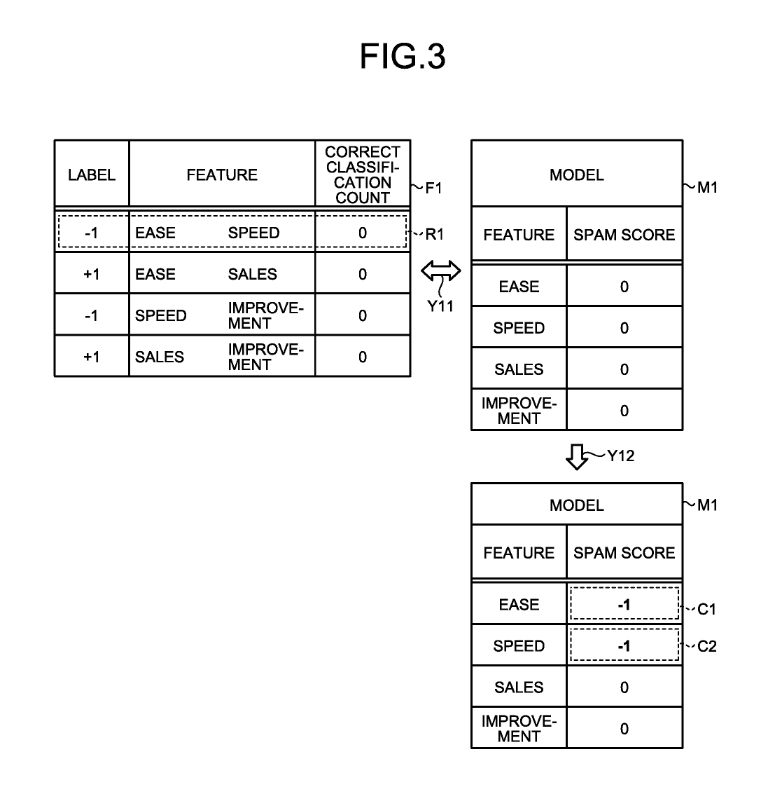

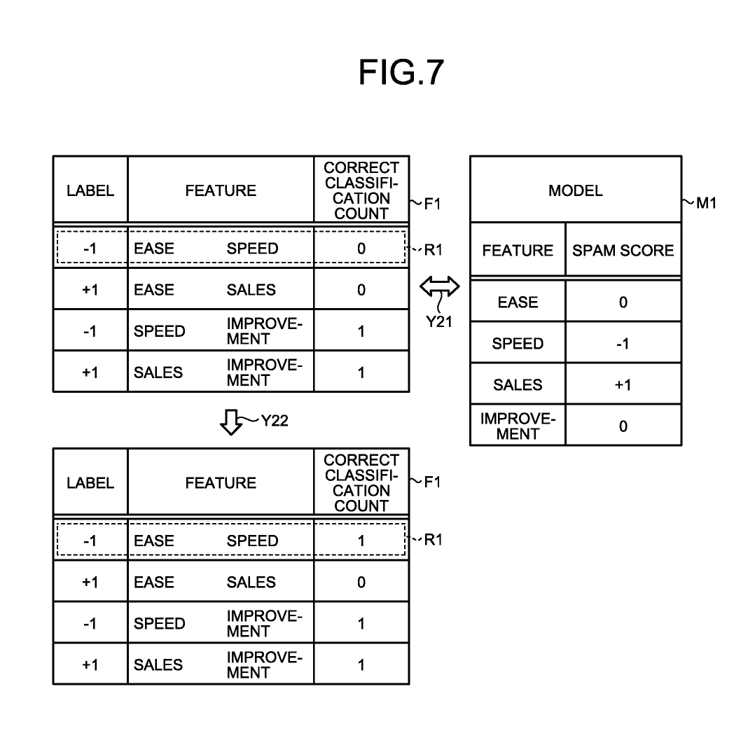

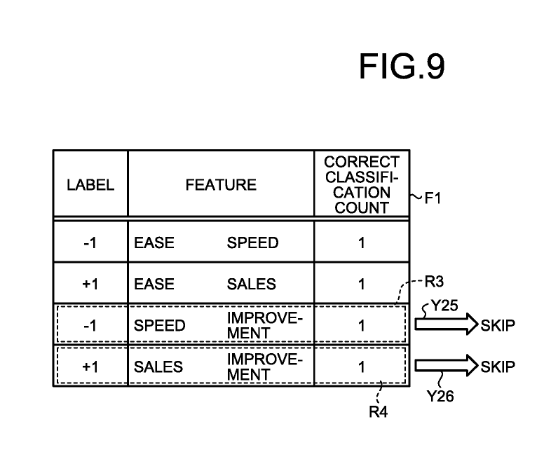

For example, there is assumed a case where the learning apparatus 10 executes processing of learning data in the first line, learning data in the second line, learning data in the third line, and learning data in the fourth line, out of the learning data illustrated in FIG. 2 in this order. FIGS. 3 to 8 are diagrams illustrating examples of cross-checking between a feature and a model and updating of the model according to the first embodiment. FIG. 9 is a diagram illustrating an example of determination with respect to cross-checking of a feature according to the first embodiment. FIGS. 3 to 6 illustrate a first round of the process for the learning data in the first to fourth lines illustrated in FIG. 2. FIGS. 7 to 9 illustrate a second round of the process for the learning data in the first to fourth lines illustrated in FIG. 2. In FIGS. 3 to 9, learning data F1 is illustrated on the left side, and a model M1 is illustrated on the right side. The acquiring unit 11 acquires a repetition count L and a threshold of “1” for the correct classification count, together with the learning data F1.

In FIGS. 3 to 9, the learning data is assigned with a spam score of “1” for “spam” and “−1” for “normal”, according to a label assigned to the learning data. In FIGS. 3 to 9, a column holding the correct classification count is associated with the learning data F1. As illustrated in FIGS. 3 to 9, the model M1 has a configuration in which the features “ease”, “speed”, “sales”, and “improvement” are associated with a spam score. In the model M1, the spam scores are “0” at the initial phase of the learning process, and the spam score is updated by the updating unit 15 upon the learning process. In learning described using FIGS. 3 to 9, a model in which given learning data is classified into any one of “+1” and “−1” is generated. One piece of learning data is taken out, and the updating unit 15 updates the model M1 when the classification is incorrect.

With reference to FIG. 3, the first round of the process for the data in the first line (see a frame_R1) of the learning data F1 is illustrated. First, when the correct classification count accumulated for the learning data that is a learning object is equal to or greater than “1”, the determining unit 12 determines that learning of the learning data is unneeded. In the example of FIG. 3, the correct classification count is “0” for the data in the first line of the learning data F1. Therefore, the determining unit 12 determines that learning of the data in the first line is needed.

Subsequently, the cross-checking unit 14 cross-checks the data in the first line of the learning data F1 with the model M1 (see Y11). When the learning data F1 to be cross-checked includes a label against the spam score of the model, the classification is incorrect (wrong).

For example, when the product of the label of the learning data and the spam score of the model is equal to or less than 0, the learning data includes a label against the spam score of the model, and the classification is incorrect. In this manner, when the product of the label of the learning data and the spam score of the model is equal to or less than 0, the cross-checking unit 14 decides that updating of the model based on the learning data is needed. In contrast, when the product of the label of the learning data and the spam score of the model is greater than 0, the learning data includes a label matching the spam score of the model, and the classification is correct. In this manner, when the product of the label of the learning data and the spam score of the model is greater than 0, the cross-checking unit 14 decides that updating of the model is unneeded.

In the example of FIG. 3, while the label is “−1” for the data in the first line of the learning data F1, the spam scores for the features “ease” and “speed” in the model M1 are both “0”. Thus, the products of the label “−1” in the first line of the learning data F1 and the spam scores “0” for the features “ease” and “speed” in the model M1 are both “0”. Therefore, for the data in the first line of the learning data F1, the cross-checking unit 14 decides that the classification is incorrect. The updating unit 15 carries out updating of the model M1 using the data in the first line of the learning data F1 (see Y12).

The updating unit 15 updates, on the basis of the label, the spam score associated with the feature matching the feature of the data in the first line of the learning data F1, out of the spam scores included in the model M1. In the example of FIG. 3, the updating unit 15 updates each of the spam scores in the model M1 for the features “ease” and “speed” illustrated in the first line of the learning data F1 to “−1”, in correspondence with the label in the first line of the learning data F1 (see columns C1 and C2 in FIG. 3).

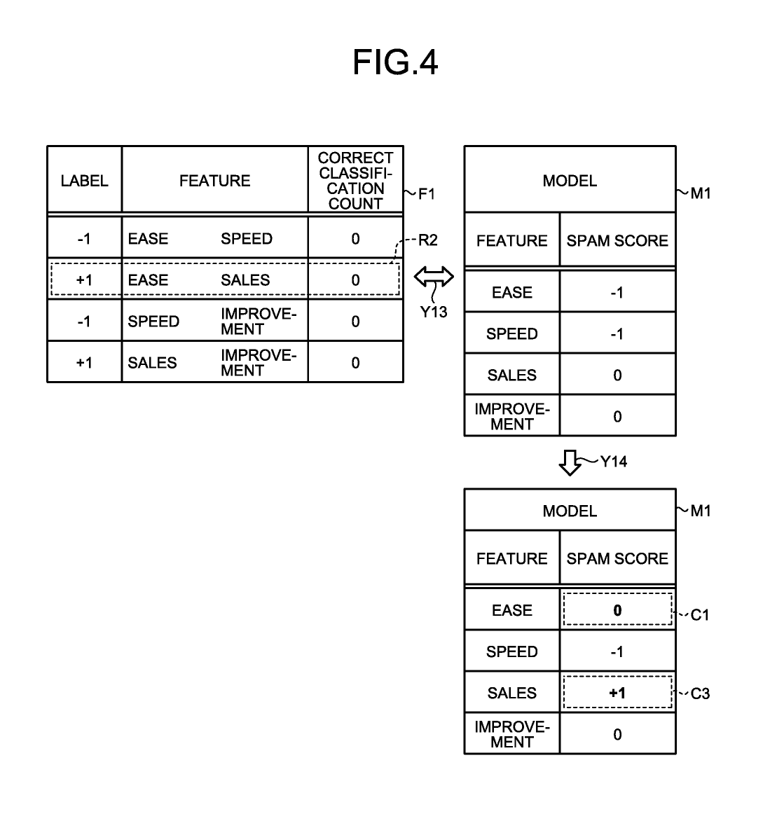

Next, with reference to FIG. 4, the first round of the process for the data in the second line (see a frame R2) of the learning data F1 is illustrated. First, because the correct classification count is “0” for the data in the second line of the learning data F1 in FIG. 4, the determining unit 12 determines that learning of the data in the second line is needed.

Subsequently, the cross-checking unit 14 cross-checks the data in the second line of the learning data F1 with the model M1 (see Y13). In the example of FIG. 4, the product of the label “+1” in the second line of the learning data F1 and the spam score “−1” for the feature “ease” in the model M1 is “−1”. Therefore, the updating unit 15 adds the label “+1” of the data in the second line to the original spam score “−1” to update (see Y14) the spam score of the feature “ease” in the model M1 to “0” (see a column C1 in FIG. 4). In the example of FIG. 4, the product of the label “+1” in the second line of the learning data F1 and the spam score “0” for the feature “sales” in the model M1 is “0”. Therefore, the updating unit 15 updates (see Y14) the spam score of the feature “sales” in the model M1 to “+1” (see a column C3 in FIG. 4), in correspondence with the label.

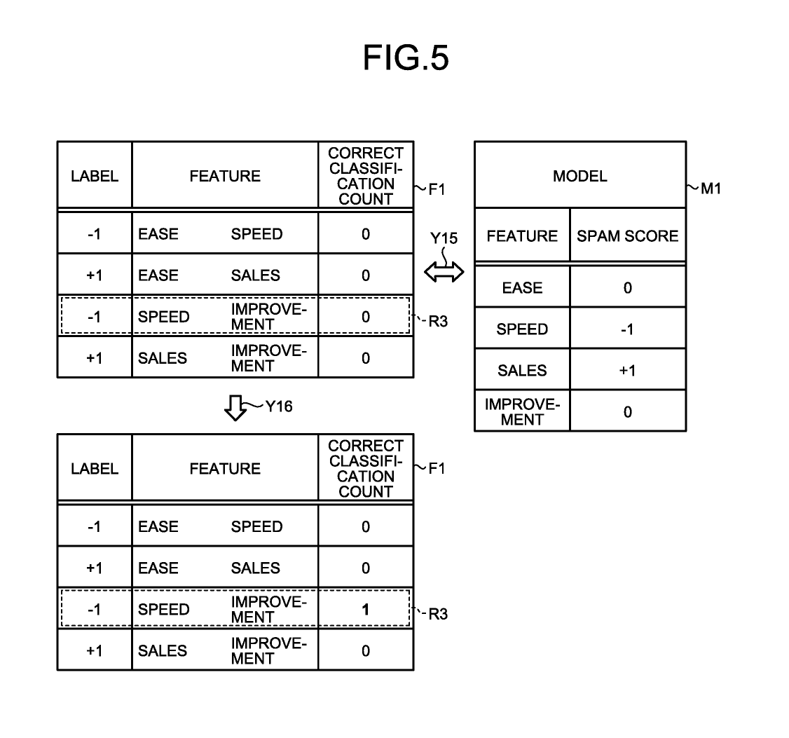

Next, with reference to FIG. 5, the first round of the process for the data in the third line (see a frame R3) of the learning data F1 is illustrated. Because the correct classification count is “0” for the data in the third line of the learning data F1, the determining unit 12 determines that learning of the data in the third line is needed. The cross-checking unit 14 cross-checks the data in the third line of the learning data F1 with the model M1 (see Y15). In the example of FIG. 5, the product of the label “−1” in the third line of the learning data F1 and the spam score “−1” for the feature “speed” in the model M1 is “1”. Therefore, for the data in the third line of the learning data F1, the cross-checking unit 14 decides not to update the model M1, because the classification is correct. The cross-checking unit 14 adds 1 to the correct classification count in the third line of the learning data F1 for a result of “1” (see Y16).

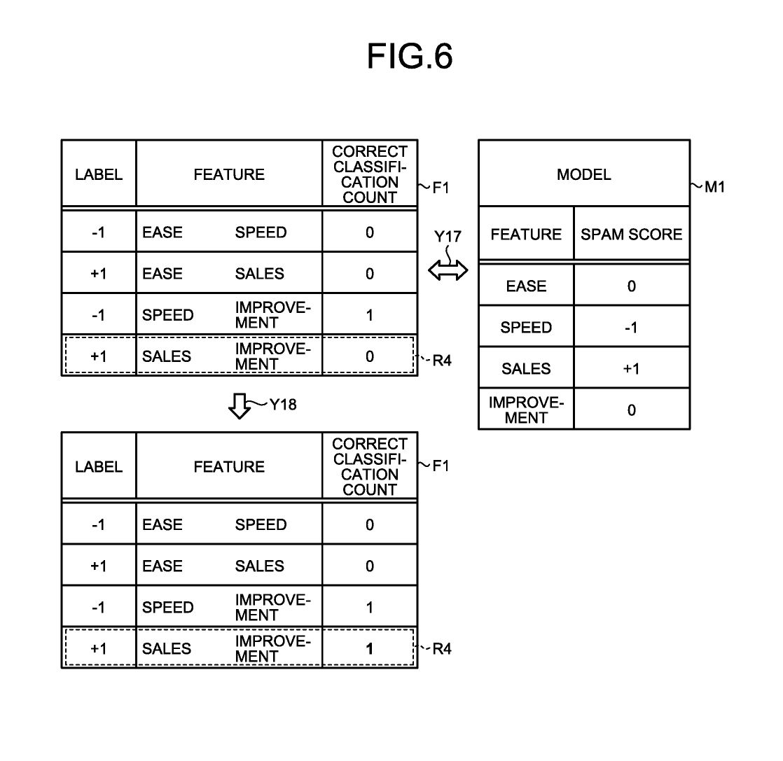

Subsequently, with reference to FIG. 6, the first round of the process for the data in the fourth line (see a frame R4) of the learning data F1 is illustrated. Because the correct classification count is “0” for the data in the fourth line of the learning data F1, the determining unit 12 determines that learning of the data in the fourth line is needed. Subsequently, the cross-checking unit 14 cross-checks the data in the fourth line of the learning data F1 with the model M1 (see Y17). In the example of FIG. 6, the product of the label “+1” in the fourth line of the learning data F1 and the spam score “+1” for the feature “sales” in the model M1 is “1”. Therefore, the cross-checking unit 14 decides not to update the model M1 and adds 1 to the correct classification count in the fourth line of the learning data F1 for a result of “1” (see Y18). The first round of the process for the learning data F1 is then terminated.

Next, the second round of the process for the learning data F1 is described. FIG. 7 is a diagram illustrating the second round of the process for the data in the first line (see the frame R1) of the learning data F1. Because the correct classification count is “0” for the data in the first line of the learning data F1 in FIG. 7, the determining unit 12 determines that learning of the data in the first line is needed. The cross-checking unit 14 cross-checks the data in the first line of the learning data F1 with the model M1 (see Y21). In the example of FIG. 7, the product of the label “−1” in the first line of the learning data F1 and the spam score “−1” for the feature “speed” in the model M1 is “1”. Therefore, the cross-checking unit 14 decides not to update the model M1. The cross-checking unit 14 adds 1 to the correct classification count in the first line of the learning data F1 for a result of “1” (see Y22).

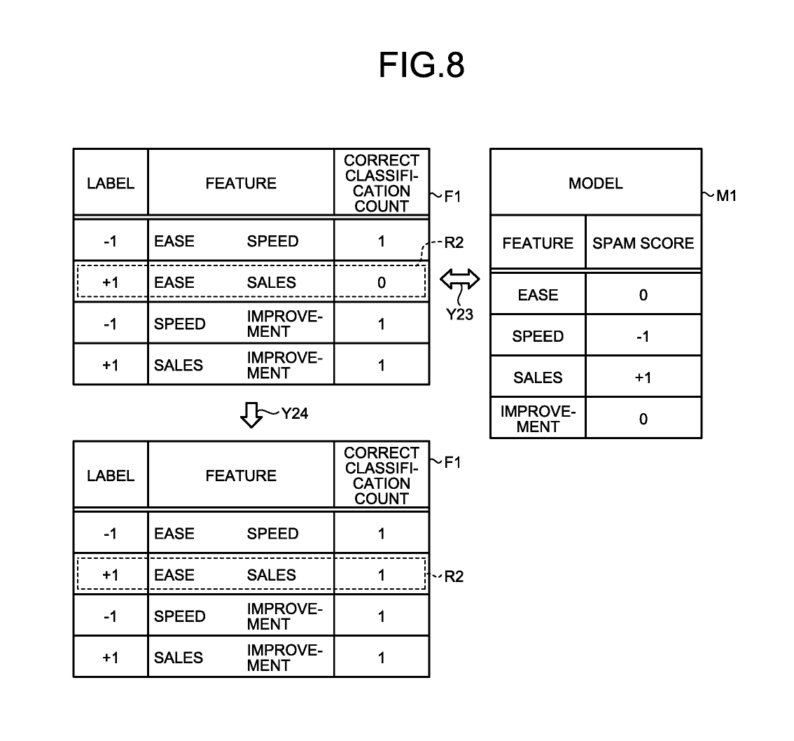

Next, with reference to FIG. 8, the second round of the process for the data in the second line (see the frame R2) of the learning data F1 is illustrated. Because the correct classification count is “0” for the data in the second line of the learning data F1, the determining unit 12 determines that learning of the data in the second line is needed. Subsequently, the cross-checking unit 14 cross-checks the data in the second line of the learning data F1 with the model M1 (see Y23). In the example of FIG. 8, the product of the label “+1” in the second line of the learning data F1 and the spam score “+1” for the feature “sales” in the model M1 is “1”. Therefore, the cross-checking unit 14 decides not to update the model M1. The cross-checking unit 14 adds 1 to the correct classification count in the second line of the learning data F1 for a result of “1” (see Y24).

Next, with reference to FIG. 9, the second round of the process for the data in the third and fourth lines (see the frames R3 and R4) of the learning data F1 is illustrated. Because the correct classification count is “1” for the data in the third line of the learning data F1, the determining unit 12 determines that learning is unneeded, and excludes the data in the third line from a learning object. In other words, in the second round, the learning apparatus 10 skips processing thereafter for cross-checking with the model M1 and updating of the model M1, for the data in the third line of the learning data F1 (see Y25). Subsequently, because the correct classification count is “1” also for the data in the fourth line of the learning data F1, the determining unit 12 determines that learning is unneeded, and excludes the data in the fourth line from a learning object. That is, the learning apparatus 10 skips processing thereafter also for the data in the fourth line of the learning data F1 (see Y26).

In this manner, for learning data of which the correct classification count is equal to or greater than “1”, the learning apparatus 10 according to the first embodiment does not execute processing for cross-checking with the model and updating of the model. Therefore, the amount of calculation needed for the processing for cross-checking with the model and updating of the model can be reduced.

Process Procedure of Learning Process

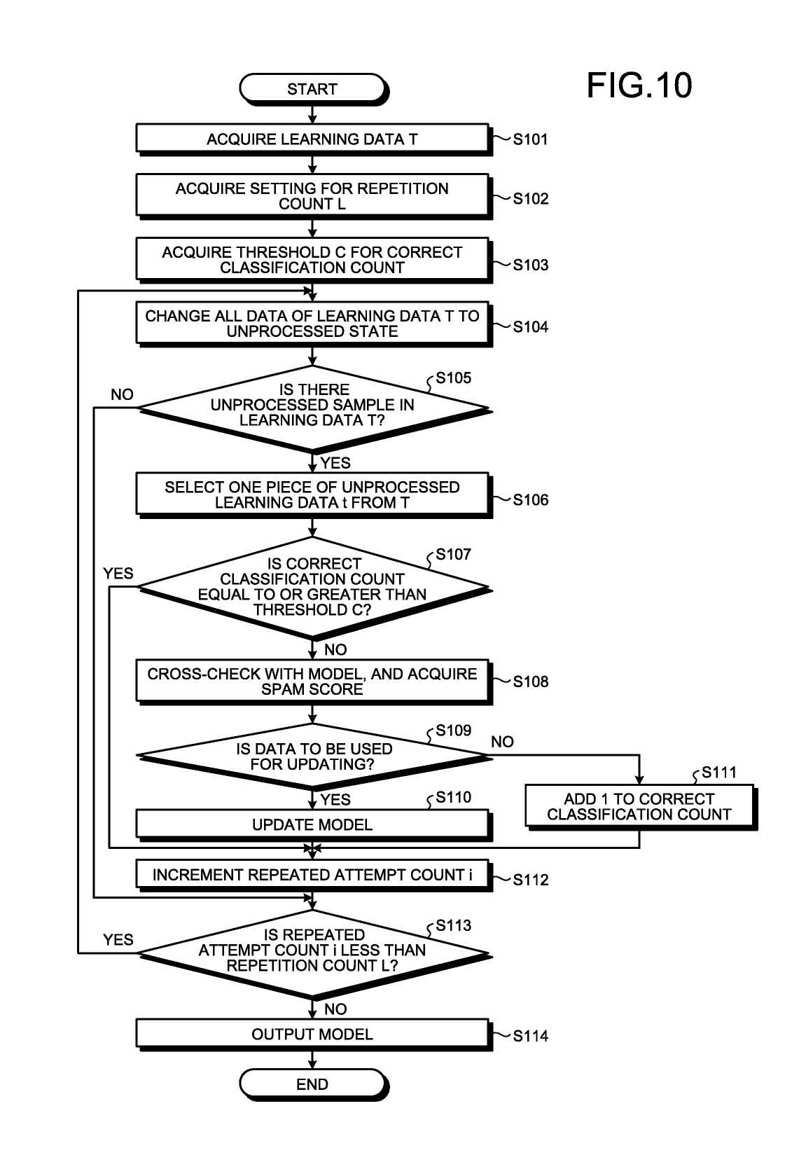

Next, a procedure of the learning process according to the first embodiment is described. FIG. 10 is a flowchart illustrating the procedure of the learning process according to the first embodiment. The learning process is started when learning is instructed by an instruction input with an input unit or the like. Alternatively, the learning process can be started automatically when learning data is acquired.

As illustrated in FIG. 10, the acquiring unit 11 acquires learning data T and acquires a setting for the repetition count L for learning (Steps S101 and S102). Further, the acquiring unit 11 acquires a threshold C for the correct classification count (Step S103). The repetition count L can be set in advance to any count, in accordance with the precision desired for the model. The threshold C for the correct classification count can be set in advance to any count, in accordance with the precision desired for the model. Processes at Steps S101 to S103 may be executed in any order and parallel execution of these processes is allowed.

Subsequently, the acquiring unit 11 sets statuses, for example, flags, related to all samples of the learning data T acquired at Step S101 to be unprocessed (Step S104). The learning apparatus 10 executes the process at Step S106 and thereafter, as long as an unprocessed sample of learning data is present in the learning data T (YES at Step S105).

That is, the acquiring unit 11 selects one piece of unprocessed learning data t from learning data T acquired at Step S101 (Step S106). The determining unit 12 refers to the correct classification count of the learning data t and decides whether the correct classification count is equal to or greater than the threshold C (Step S107). In other words, at Step S107, the determining unit 12 compares the correct classification count, which is a decision result related to updating of the model accumulated for the learning data t, with a condition that the correct classification count is equal to or greater than the threshold C to determine whether learning of the learning data t is needed. When the correct classification count of the learning data t is decided to be equal to or greater than the threshold C (YES at Step S107), the determining unit 12 excludes the learning data t from a learning object and proceeds the process to Step S112.

When the determining unit 12 has determined that the correct classification count of the learning data t is not equal to or greater than the threshold C (NO at Step S107), the learning process for the learning data t is executed. Specifically, the cross-checking unit 14 cross-checks a feature of the learning data t with a feature included in the model stored in the model storage unit 13 and acquires a spam score (Step S108).

Subsequently, the cross-checking unit 14 decides whether the learning data t to be cross-checked is data used for updating the model (Step S109). Specifically, when the classification of the learning data t with the spam score obtained by cross-checking at Step S108 is wrong, the cross-checking unit 14 decides that the learning data t is data used for updating the model.

When the cross-checking unit 14 has decided that the learning data t to be cross-checked is data used for updating the model (YES at Step S109), the updating unit 15 updates the model, on the basis of the learning data t (Step S110). Specifically, the updating unit 15 performs updating such that a spam score assigned to a label of the learning data t is added to the current spam score associated with the feature included in the model. On the other hand, when the learning data t to be cross-checked is decided as not data used for updating the model (NO at Step S109), the cross-checking unit 14 adds 1 to the correct classification count of the learning data t (Step S111).

When the determining unit 12 has determined that the correct classification count of the learning data t is equal to or greater than the threshold C (YES at Step S107), the learning apparatus 10 increments a repeated attempt count i held in a register or the like (not illustrated) (Step S112), after the process at Step S110 or Step S111.

When an unprocessed sample of the learning data is not present in the learning data T (NO at Step S105) or after the process at Step S112, the learning apparatus 10 determines whether the repeated attempt count i is less than the repetition count L (Step S113). When the repeated attempt count i is determined to be less than the repetition count L (YES at Step S113), the learning apparatus 10 shifts to Step S104 and repeats execution of processes from Step S104 to Step S113.

On the other hand, when the learning apparatus 10 has determined that the repeated attempt count i has reached the repetition count L (NO at Step S113), the updating unit 15 outputs the model stored in the model storage unit 13 to a predetermined output destination (Step S114) and terminates the process. Examples of the output destination for the model include an application program that executes a filtering process for e-mails. When generating of a model is requested from an external apparatus, a response can be made to the request source.

### Effect of the First Embodiment

According to the first embodiment, a predetermined condition and a decision result related to updating of a model accumulated for learning data are compared to determine whether learning of the learning data is needed, and learning data of which learning is determined to be unneeded is excluded from a learning object. Therefore, the amount of calculation needed a learning process can be reduced.

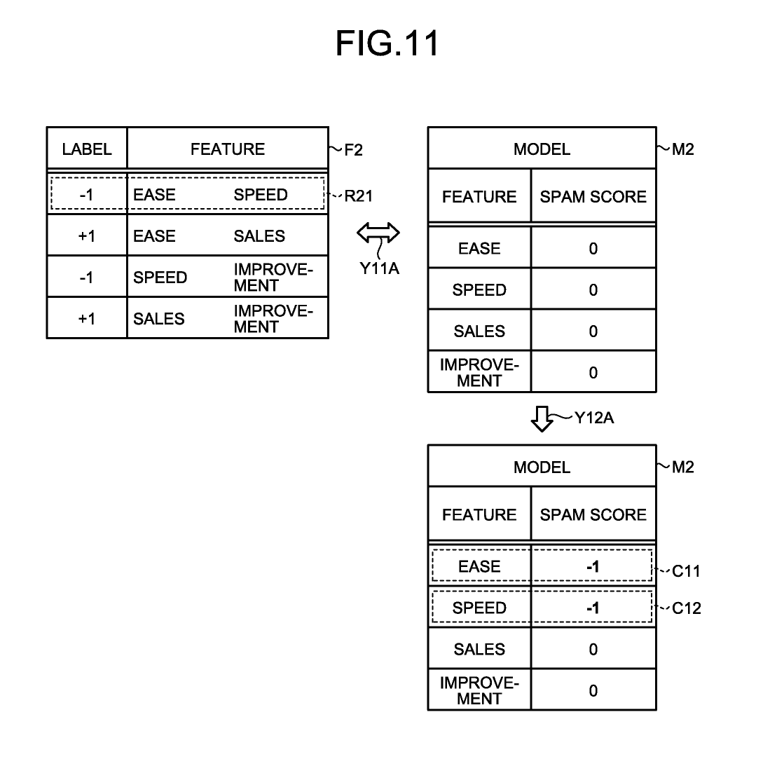

The amount of processing for the learning process according to the present embodiment and the amount of processing for a general learning process are compared with each other. FIGS. 11 to 18 are diagrams illustrating examples of cross-checking between a feature and a model and updating of the model according to a comparative example. For comparison with the first embodiment, FIGS. 11 to 18 illustrate an example of executing a learning process using learning data F2 identical to the learning data F1 used in FIGS. 3 to 9.

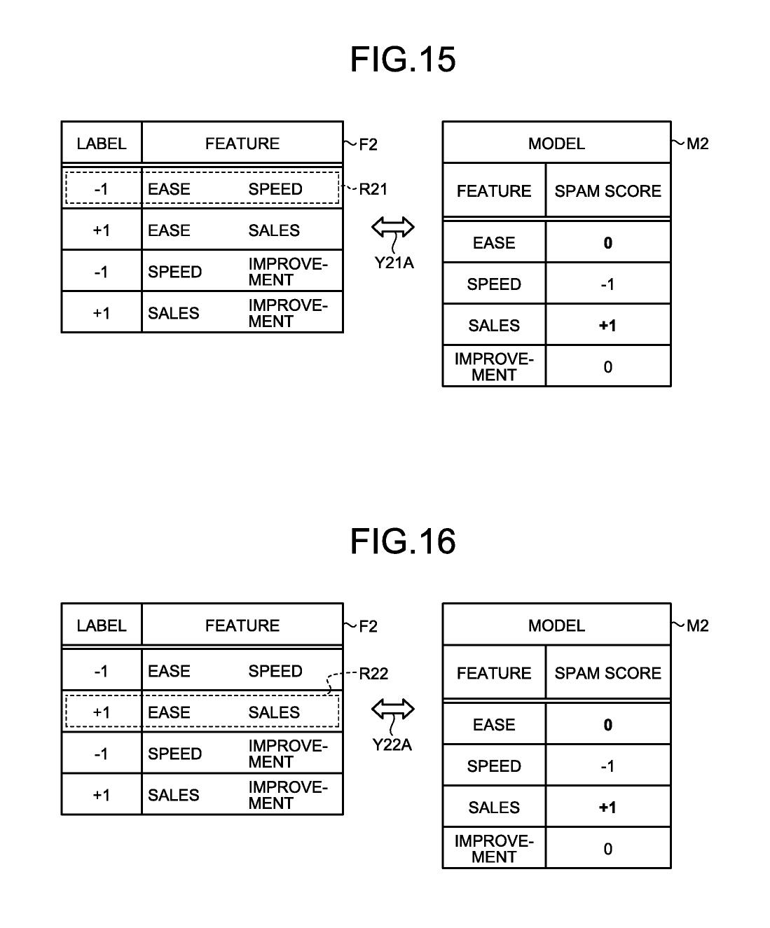

FIGS. 11 to 14 illustrate a first round of the process for the learning data in the first to fourth lines illustrated in FIG. 2, in the learning process of the comparative example. FIGS. 15 to 18 illustrate a second round of the process for the learning data in the first to fourth lines illustrated in FIG. 2. In FIGS. 11 to 18, the learning data F2 is illustrated on the left side, and a model M2 is illustrated on the right side, in a similar manner to FIGS. 3 to 9. First, in the learning process according to the comparative example, the first round of the process for the learning data F2 is described.

As illustrated in FIG. 11, in the learning process of the comparative example, the data in the first line of the learning data F2 (see a frame R21) and the model M2 are cross-checked (see Y11A). In the example of FIG. 11, while the label is “−1” for the data in the first line of the learning data F2, the spam scores for the features “ease” and “speed” in the model M2 are both “0”. Thus, the products of the label “−1” in the first line of the learning data F2 and the spam scores “0” for the features “ease” and “speed” in the model M2 are both “0”. Therefore, in the example of FIG. 11, updating of the model M2 is carried out using the data in the first line of the learning data F2 (see Y12A). As a result, the spam scores for the features “ease” and “speed” in the model M2 are respectively updated to “−1” corresponding to the label in the first line of the learning data F2 (see columns C11 and C12 in FIG. 11).

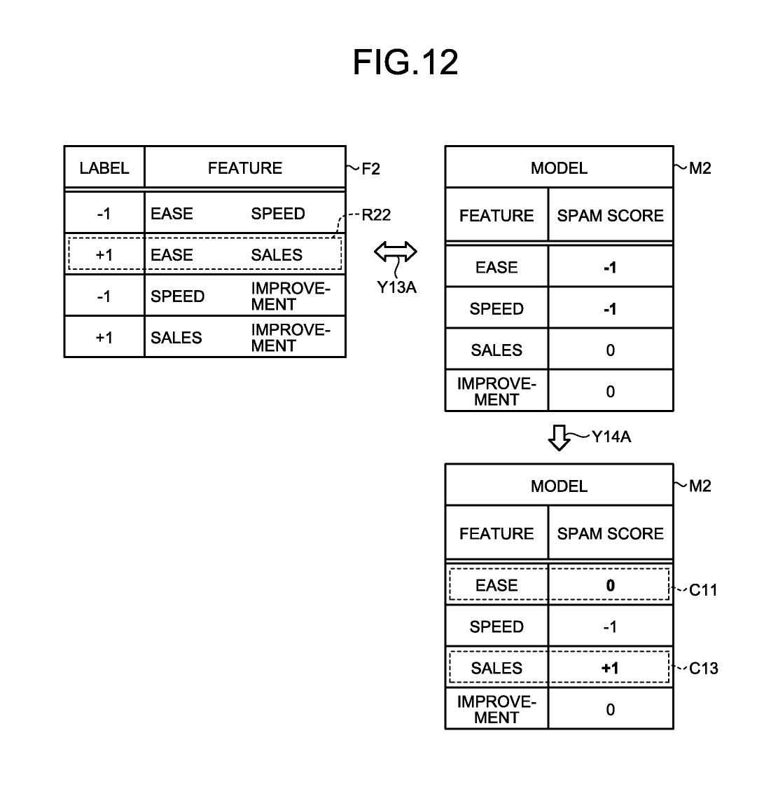

Subsequently, in the learning process of the comparative example, the data in the second line of the learning data F2 (see a frame R22) and the model M2 are cross-checked (see Y13A), as illustrated in FIG. 12. In the example of FIG. 12, the product of the label “+1” in the second line of the learning data F2 and the spam score “−1” for the feature “ease” in the model M2 is “−1”. The product of the label “+1” in the second line of the learning data F2 and the spam score “0” for the feature “sales” in the model M2 is “0”. Therefore, in a similar manner to the example illustrated in FIG. 4, the spam score for the feature “ease” in the model M2 is updated (see Y14A) to “0” (see a column C11 in FIG. 12) with the addition of the label “+1” of the data in the second line. The spam score for the feature “sales” is updated to “+1” (see a column C13 in FIG. 12), in correspondence with the label.

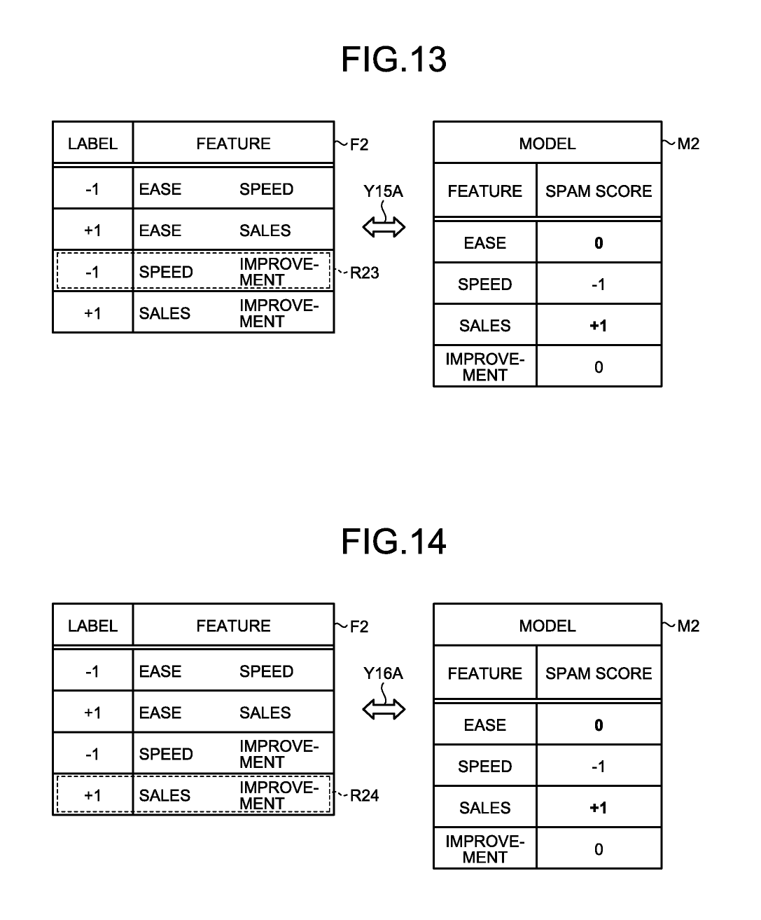

Next, in the learning process of the comparative example, the data in the third line of the learning data F2 (see a frame R23) and the model M2 are cross-checked (see Y15A), as illustrated in FIG. 13. In the example of FIG. 13, the product of the label “−1” in the third line of the learning data F2 and the spam score “−1” for the feature “speed” in the model M2 is “1”. Therefore, in the learning process of the comparative example, the model M2 is not updated.

Subsequently, in the learning process of the comparative example, the data in the fourth line of the learning data F2 (see a frame R24) and the model M2 are cross-checked (see Y16A), as illustrated in FIG. 14. In the example of FIG. 14, the product of the label “+1” in the fourth line of the learning data F2 and the spam score “+1” for the feature “sales” in the model M2 is “1”. Therefore, in the learning process of the comparative example, the model M2 is not updated. The first round of the process for the learning data F2 is then terminated.

Next, in the learning process according to the comparative example, the second round of the process for the learning data F2 is described. First, in the learning process of the comparative example, the data in the first line of the learning data F2 (see the frame R21) and the model M2 are cross-checked (see Y21A), as illustrated in FIG. 15. In the example of FIG. 15, the product of the label “−1” in the first line of the learning data F2 and the spam score “−1” for the feature “speed” in the model M2 is “1”. Therefore, the model M2 is not updated.

Subsequently, in the learning process of the comparative example, the data in the second line of the learning data F2 (see the frame R22) and the model M2 are cross-checked (see Y22A), as illustrated in FIG. 16. In the example of FIG. 16, the product of the label “+1” in the second line of the learning data F2 and the spam score “+1” for the feature “sales” in the model M2 is “1”. Therefore, the model M2 is not updated.

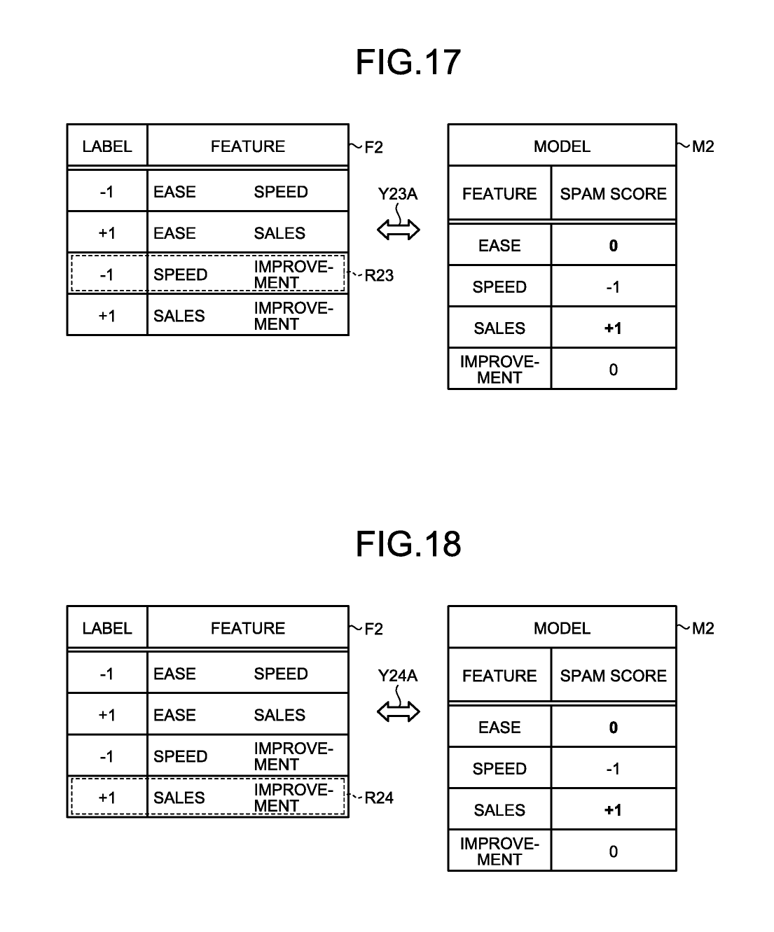

Subsequently, in the learning process of the comparative example, the data in the third line of the learning data F2 (see the frame R23) and the model M2 are cross-checked (see Y23A), as illustrated in FIG. 17. In the example of FIG. 17, the product of the label “−1” in the third line of the learning data F2 and the spam score “−1” for the feature “speed” in the model M2 is “1”. Therefore, the model M2 is not updated.

Next, in the learning process of the comparative example, the data in the fourth line of the learning data F2 (see the frame R24) and the model M2 are cross-checked (see Y24A), as illustrated in FIG. 18. In the example of FIG. 18, the product of the label “+1” in the fourth line of the learning data F2 and the spam score “+1” for the feature “sales” in the model M2 is “1”. Therefore, the model M2 is not updated. As illustrated in FIG. 18, the model M2 obtained in the learning process according to the comparative example is identical to the model M1 obtained in the learning process according to the first embodiment.

In this manner, in the general learning process, classification is performed redundantly for learning data that can be classified correctly. That is, in the general learning process, classification is performed for the data in the third line of the learning data F2 and the data in the fourth line of the learning data F2 also in the second round, even though the classification has been correct in the first round. Thus, in the general learning process, a certain amount of calculation is needed because cross-checking with a model and evaluation are performed every time, even for a feature with multiple consecutive instances of correct classification.

There are cases where the evaluation for data of the same type in data that is a learning object does not change that frequently. The model M2 illustrated in FIG. 18 is actually identical to the model M1 obtained in the learning process according to the first embodiment. Thus, performing cross-checking with a model and evaluation every time for data of the same type results in an increase in the calculation time without improving model contents.

In contrast, in the learning process according to the first embodiment, the correct classification count for each piece of learning data with respect to a model is accumulated, and learning data of which the correct classification count has become equal to or greater than a threshold is excluded from a learning object. As described with FIG. 9, actually, in the second round of the process for the learning data F1, the learning apparatus 10 excludes, from a learning object, the learning data in the third and fourth lines, for which classification has been correct in the first round, and does not execute processing for cross-checking with the model and updating of the model.

Therefore, in the first embodiment, the amount of calculation needed for the processing for cross-checking with the model and updating of the model for learning data of which the correct classification count has become equal to or greater than the threshold can be reduced, as compared to the general learning process. Thus, according to the first embodiment, reduction in the calculation time needed for the learning process and reduction in the amount of memory used for the learning process can be also achieved, as compared to the general learning process.

Another Process Procedure of Learning Process

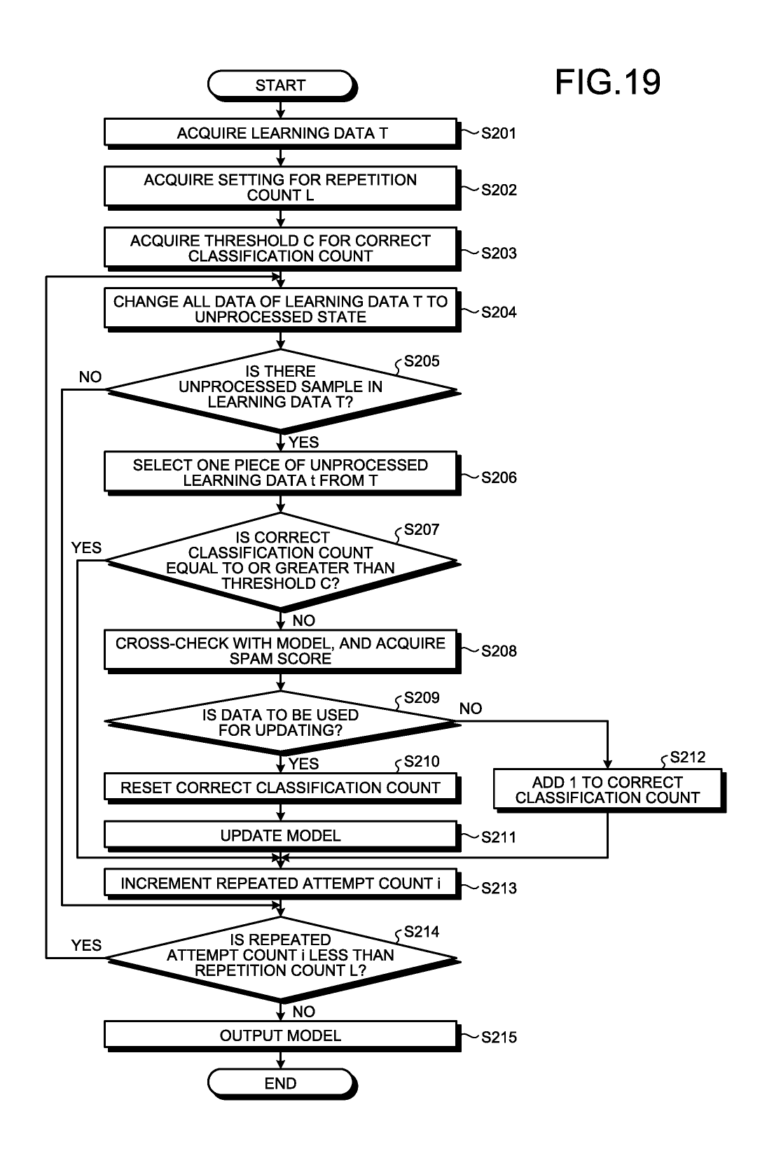

Next, a modification of the first embodiment is described. FIG. 19 is a flowchart illustrating another procedure of the learning process according to the first embodiment.

Steps S201 to S209 illustrated in FIG. 19 are processes identical to those at Steps S101 to S109 illustrated in FIG. 10, and therefore redundant descriptions thereof are omitted. In the following descriptions, redundant descriptions of respective steps in FIG. 19 corresponding to respective steps in FIG. 10 are omitted. When the learning data t to be cross-checked is determined as data used for updating the model (YES at Step S209), the cross-checking unit 14 resets the correct classification count accumulated for the learning data t (Step S210). Step S211 corresponds to Step S110 illustrated in FIG. 10. Step S212 corresponds to Step S111 illustrated in FIG. 10. Steps S213 to S215 correspond to Steps S112 to S114 illustrated in FIG. 10.

In the learning process illustrated in FIG. 19, the correct classification count is reset for the learning data t that has been classified once as wrong. By resetting the correct classification count at an appropriate timing in the learning process illustrated in FIG. 19 in this manner, a certain degree of evaluation is ensured for the model.

Another Process Procedure of Learning Process

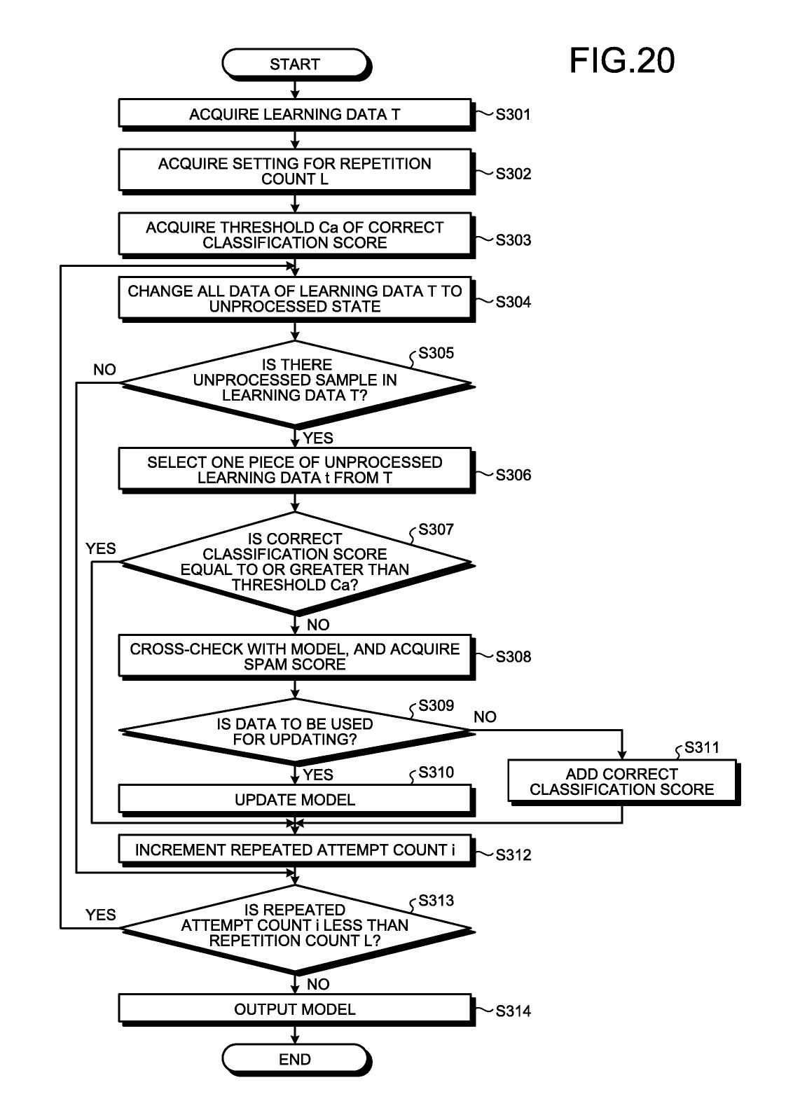

Next, another modification of the first embodiment is described. In the learning apparatus 10, the cross-checking unit 14 may accumulate a correct classification score indicating reliability for correct classification for each piece of learning data with respect to the model, instead of the correct classification count. In the learning apparatus 10, the determining unit 12 may perform determination to exclude, from a learning object, learning data of which the correct classification score has become equal to or greater than a threshold. FIG. 20 is a flowchart illustrating another procedure of the learning process according to the first embodiment. Because Step S301 and Step S302 illustrated in FIG. 20 have identical processes as those at Step S101 and Step S102 illustrated in FIG. 10, descriptions thereof are omitted. In the following explanations, descriptions of respective steps of FIG. 20 corresponding to those in FIG. 10 are omitted.

The acquiring unit 11 acquires a threshold Ca of the correct classification score (Step S303). The threshold Ca of the correct classification score can be set in advance to any value, in accordance with the precision desired for the model. Steps S304 to S306 correspond to Steps S104 to S106 illustrated in FIG. 10. The determining unit 12 refers to the correct classification score of the learning data t and decides whether the correct classification score is equal to or greater than the threshold Ca (Step S307). When the correct classification score of the learning data t is decided to be equal to or greater than the threshold Ca (YES at Step S307), the determining unit 12 excludes the learning data t from a learning object and proceeds the process to Step S312. On the other hand, when the determining unit 12 has determined that the correct classification score of the learning data t is not equal to or greater than the threshold Ca (NO at Step S307), the learning process for the learning data t is executed. Steps S308 to S310 correspond to Steps S108 to S110 illustrated in FIG. 10. When the learning data t to be cross-checked is determined as not data used for updating the model (NO at Step S309), the cross-checking unit 14 adds the correct classification score of the learning data t (Step S311).

When the determining unit 12 has decided that the correct classification score of the learning data t is equal to or greater than the threshold Ca (YES at Step S307), the learning apparatus 10 proceeds the process to Step S312 after the process at Step S310 or Step S311. Steps S312 to S314 correspond to Steps S112 to S114 illustrated in FIG. 10.

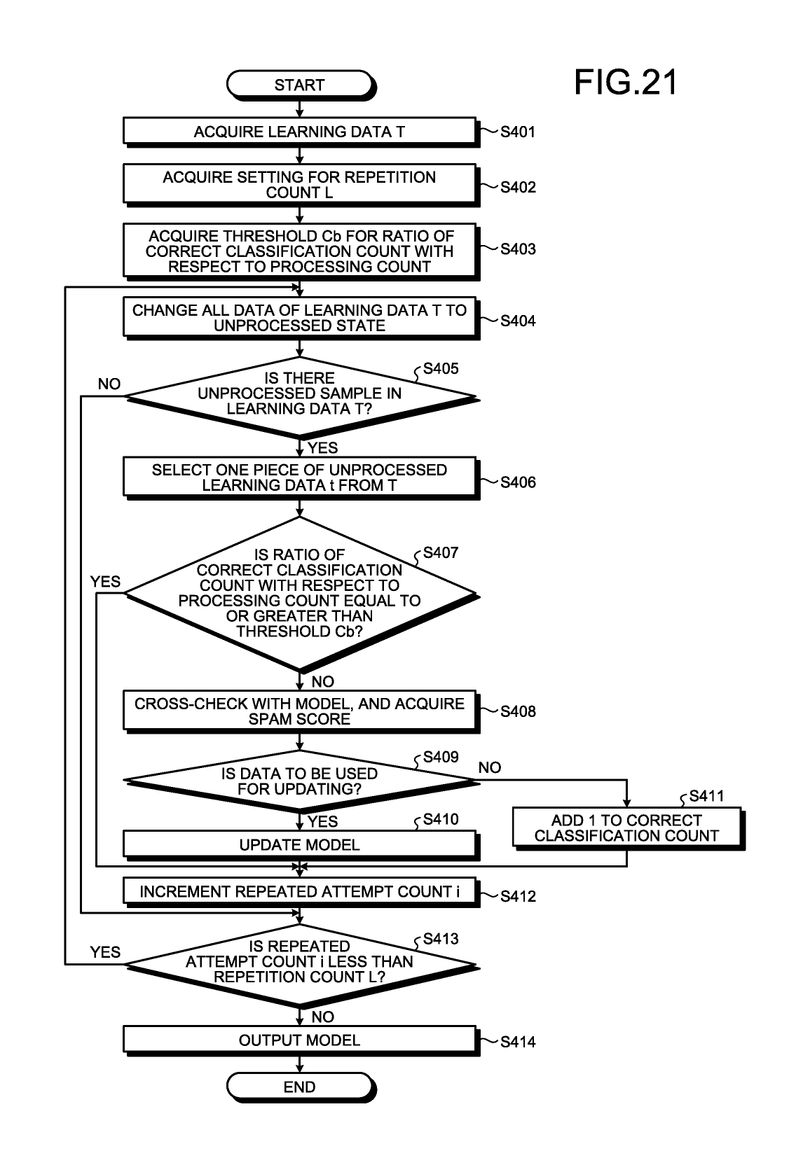

In the learning apparatus 10, the determining unit 12 may perform determination to exclude, from a learning object, learning data for which the ratio of the correct classification count with respect to the processing count has become equal to or greater than a predetermined threshold. A specific description is given with reference to FIG. 21.

FIG. 21 is a flowchart illustrating another procedure of the learning process according to the first embodiment. Because Step S401 and Step S402 illustrated in FIG. 21 have identical processes as those at Step S101 and Step S102 illustrated in FIG. 10, descriptions thereof are omitted. In the following explanations, redundant descriptions of respective steps in FIG. 21 corresponding to respective steps in FIG. 10 are omitted. The acquiring unit 11 acquires a threshold Cb for the ratio of the correct classification count with respect to the processing count (Step S403). The threshold Cb for the ratio can be set in advance to any value in accordance with the precision desired for the model. Steps S404 to S406 correspond to Steps S104 to S106 illustrated in FIG. 10.

The determining unit 12 refers to the correct classification count and the processing count of the learning data t, calculates the ratio of the correct classification count with respect to the processing count, and determines whether the calculated ratio is equal to or greater than the threshold Cb (Step S407). When the ratio of the correct classification count with respect to the processing count for the learning data t is decided to be equal to or greater than the threshold Cb (YES at Step S407), the determining unit 12 excludes the learning data t from a learning object and proceeds the process to Step S412. When the determining unit 12 has determined that the ratio of the correct classification count with respect to the processing count for the learning data t is not equal to or greater than the threshold Cb (NO at Step S407), the learning process for the learning data t is executed. Steps S408 to S414 correspond to Steps S108 to S114 illustrated in FIG. 10.

### Specific Application Example

There is described an example in which the learning process according to the first embodiment is specifically applied to a newspaper-making process. In this example, a created article corresponds to text data and a section such as the front page, the economic section, the cultural section, or the social section corresponds to a label assigned to the text data. A model is set for the number of the sections, and a score is associated with each feature. A learning process is executed in advance to create a model, with multiple existing articles in each section as learning data.

The learning apparatus then 10 applies the learning process according to the first embodiment for a newly created article, determines whether learning is needed, and performs cross-checking with the model and updating of the model when learning is needed. As a result, the learning apparatus 10 outputs a likely section for the article. By applying the first embodiment in this manner, the learning apparatus 10 automatically presents which section is favorable for the created article to be carried in, and thus the time to be taken for a newspaper editor to select the section can be reduced.

Distribution and Integration

Respective constituent elements of respective devices illustrated in the drawings do not need to be physically configured in the way as illustrated in these drawings. That is, the specific mode of distribution and integration of respective devices is not limited to the illustrated ones and all or a part of these units can be functionally or physically distributed or integrated in an arbitrary unit, according to various kinds of load and the status of use. For example, the acquiring unit 11, the determining unit 12, the cross-checking unit 14, or the updating unit 15 can be connected through a network as the external device of the learning apparatus 10. It is also possible to configure that other devices include the acquiring unit 11, the determining unit 12, the cross-checking unit 14, or the updating unit 15 respectively and these units are connected to a network and cooperate to realize the functions of the learning apparatus 10 described above.

Learning Program

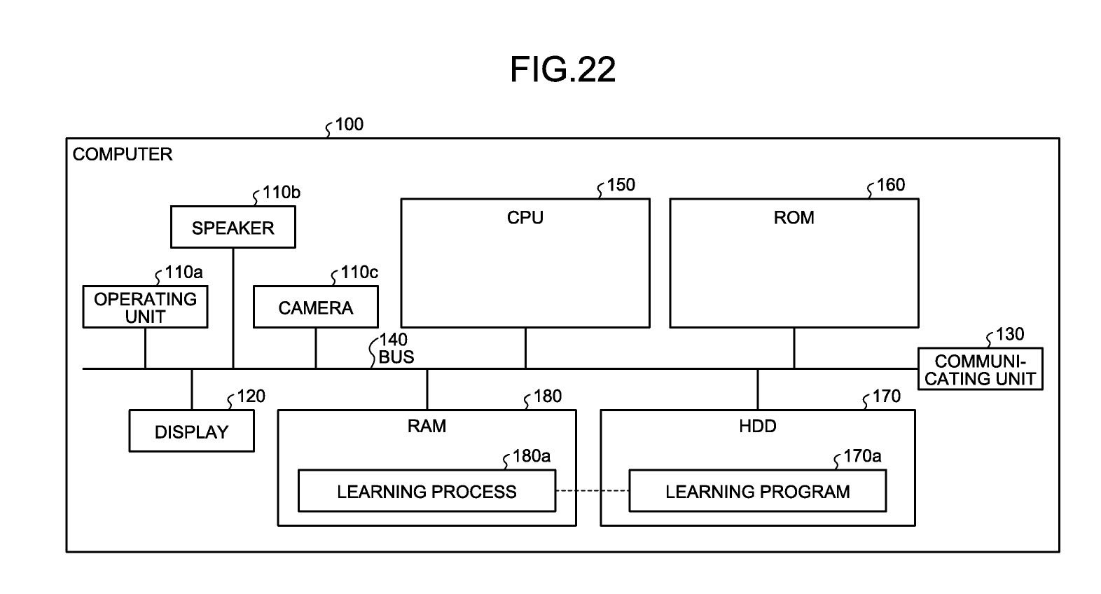

Various processes described in the above embodiment can be realized by executing a program prepared in advance with a computer such as a personal computer or a workstation. In the following descriptions, with reference to FIG. 22, an example of a computer that executes a learning program having functions identical to those of the above embodiment is described.

FIG. 22 is a diagram illustrating a hardware configuration example of a computer that executes the learning program according to the first embodiment. As illustrated in FIG. 22, a computer 100 includes an operating unit 110a, a speaker 110b, a camera 110c, a display 120, and a communicating unit 130. Further, the computer 100 includes a CPU (Central Processing Unit) 150, a ROM (Read Only Memory) 160, an HDD (Hard Disk Drive) 170, and a RAM (Random Access Memory) 180. The respective units 110 to 180 are connected via a bus 140.

As illustrated in FIG. 22, the HDD 170 stores therein a learning program 170a that exhibits functions identical to those of the acquiring unit 11, the determining unit 12, the cross-checking unit 14, and the updating unit 15 illustrated in the first embodiment. The learning program 170a can be integrated or distributed in a similar manner to the respective constituent elements of the acquiring unit 11, the determining unit 12, the cross-checking unit 14, and the updating unit 15 illustrated in FIG. 1. That is, the HDD 170 does not need to store therein all data illustrated in the first embodiment, as long as data used for processing is stored in the HDD 170.

Under such an environment, the learning program 170a is read from the HDD 170 and loaded into the RAM 180 by the CPU 150. As a result, the learning program 170a functions as a learning process 180a as illustrated in FIG. 22. The learning process 180a loads various data read from the HDD 170 into an area allocated to the learning process 180a out of a storage area included in the RAM 180, and executes various processes using the various loaded data. Examples of the processes executed by the learning process 180a include the processes illustrated in FIG. 10 and FIGS. 19 to 21. With the CPU 150, it is not needed that all the processing units illustrated in the first embodiment are operated, as long as processing units corresponding to processes to be executed are virtually realized.

The learning program 170a described above does not need to be stored in advance in the HDD 170 or the ROM 160. For example, the learning program 170a is stored in a “portable physical medium” such as a flexible disk, a so-called FD, a CD-ROM, a DVD disk, a magneto-optical disk, and an IC card inserted into the computer 100. The computer 100 can acquire the learning program 170a from such portable physical media and execute the learning program 170a. Further, it is possible to configure that the learning program 170a is stored in another computer or server device to be connected to the computer 100 via a public communication line, the Internet, a LAN, or a WAN, and the computer 100 acquires and executes the learning program 170a from such media.

The amount of calculation needed for a learning process is reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a learning program that causes a computer to execute a process comprising:
acquiring learning data that is a learning object for a model in which data and confidence of the data are associated with each other;
determining whether learning of the learning data is needed by comparing a predetermined condition with a decision result related to updating of the model accumulated for the learning data acquired at the acquiring; and
excluding, from a learning object, the learning data of which learning is determined to be unneeded at the determining.

2. The non-transitory computer-readable recording medium according to claim 1, wherein the process further comprises:
deciding whether learning data to be cross-checked is data used for updating the model, by cross-checking, with the model, the learning data of which learning is determined to be needed at the determining;
updating the model based on the learning data when the learning data to be cross-checked is decided as data used for updating the model at the deciding; and
accumulating a decision result for the learning data to be cross-checked at the deciding.

3. The non-transitory computer-readable recording medium according to claim 2, wherein
the learning data includes a label of a positive instance or a negative instance and a feature amount,
the model learns learning data including a label against confidence of the model as a wrong instance, and
the deciding includes deciding the learning data to be cross-checked as data used for updating the model when the learning data to be cross-checked includes a label against the confidence of the model, and deciding the learning data to be cross-checked as not data used for updating the model when the learning data to be cross-checked includes a label corresponding to the confidence of the model.

4. The non-transitory computer-readable recording medium according to claim 3, wherein
the accumulating includes accumulating a correct classification count indicating a count for correctly classified instances for the learning data decided as not data used for updating the model at the deciding, and
the determining includes determining learning of the learning data to be unneeded, when the correct classification count accumulated for the learning data acquired at the acquiring is equal to or greater than a predetermined threshold.

5. The non-transitory computer-readable recording medium according to claim 3, wherein
the accumulating includes accumulating a correct classification score indicating reliability for correct classification for the learning data decided as not data used for updating the model at the deciding, and
the determining includes determining learning of the learning data to be unneeded, when the correct classification score accumulated for the learning data acquired at the acquiring is equal to or greater than a predetermined threshold.

6. The non-transitory computer-readable recording medium according to claim 3, wherein
the accumulating includes accumulating a correct classification count indicating a count for correctly classified instances for the learning data decided as not data used for updating the model at the deciding, and
the determining includes determining learning of the learning data to be unneeded, when a ratio with respect to a processing count of the correct classification count accumulated for the learning data acquired at the acquiring is equal to or greater than a predetermined threshold.

7. The non-transitory computer-readable recording medium according to claim 3, wherein the process further comprises:
resetting the decision result accumulated for the learning data, when the learning data to be cross-checked is decided as data used for updating the model at the deciding.

8. The non-transitory computer-readable recording medium according to claim 1, wherein
the learning data is a text, and
the acquiring includes acquiring a feature included in the text as the learning object.

9. A learning method comprising:
acquiring learning data that is a learning object for a model in which data and confidence of the data are associated with each other, using a processor;
determining whether learning of the learning data is needed by comparing a predetermined condition with a decision result related to updating of the model accumulated for the learning data acquired at the acquiring, using the processor; and
excluding, from a learning object, the learning data of which learning is determined to be unneeded at the determining, using the processor.

10. A learning apparatus comprising:
a memory; and
a processor coupled to the memory, wherein the processor executes a process comprising:
acquiring learning data that is a learning object for a model in which data and confidence of the data are associated with each other;
determining whether learning of the learning data is needed by comparing a predetermined condition with a decision result related to the model for the learning data accumulated for the learning data acquired at the acquiring; and
excluding, from a learning object, the learning data of which learning is determined to be unneeded.
